(19) United States
(12) Patent Application Publication
(10) Pub. No.: US 2010/0085319 A1
(43) Pub. Date: Apr. 8, 2010

(54) ORGANIC ELECTROCONDUCTIVE POLYMER COATING LIQUID, ORGANIC ELECTROCONDUCTIVE POLYMER FILM, ELECTRIC CONDUCTOR, AND RESISTIVE FILM TOUCH PANEL

(76) Inventors: Naoyuki HAYASHI, Kanagawa (JP); Takashi Kato, Kanagawa (JP)

Correspondence Address: BIRCH STEWART KOLASCH & BIRCH, PO BOX 747, FALLS CHURCH, VA, 22040-0747, US

(21) Appl. No.: 12/571,125

(22) Filed: Sep. 30, 2009

(30) Foreign Application Priority Data
Oct. 6, 2008 (JP) 2008-259769
Aug. 21, 2009 (JP) 2009-192457

(51) Int. Cl. G06F 3/041; H01B 1/12

(52) U.S. Cl. 345/173; 252/500

(57) ABSTRACT

The organic electroconductive polymer coating liquid of the present invention contains an electroconductive polymer and a dopant, which is a water-soluble polymer, dispersed in at least one of a monohydric alcohol, a ketone or water. The viscosity of this dispersion is 6.0 mPa·s or less, and the average value of a dispersed particle diameter of the electroconductive polymer and the dopant is 50 nm or less.

### CROSS REFERENCE TO RELATED APPLICATIONS

This application claims priority under 35 USC 119 from Japanese Patent Application Nos. 2008-259769, filed on Oct. 6, 2008, and 2009-192457, filed on Aug. 21, 2009, the disclosure of which is incorporated herein by reference.

### BACKGROUND OF THE INVENTION

1. Field of the Invention

The present invention relates to an organic electroconductive polymer coating liquid, an organic electroconductive polymer film, an electric conductor, and a resistive film touch panel.

2. Description of the Related Art

In recent years, displays typified by liquid crystal displays (LCD), plasma display panels (PDP), electroluminescence (EL) devices, or the like have increasingly been used widely in various fields such as television sets, computers and various types of mobile instruments which have recently been spreading increasingly, and are undergoing remarkable development. On the other hand, solar batteries are attracting attention as one of the non-fossil energies which pay consideration to the global environment. In order to address the need for further spread of solar batteries, research for improving the functions thereof and the like has been demanded. In such display devices and solar batteries, electroconductive films are used.

Generally, electroconductive films using metallic materials, such as ITO-based electroconductive films, are produced by forming, on a glass substrate, a film from a metallic material by a vapor phase method such as a vacuum deposition method or a sputtering method. Display devices of cellular phones and mobile instruments have been becoming lighter in weight, and it has been demanded that display device substrates be shifted from glass to plastic. The introduction of plastic substrates has reduced the weight of display devices to half or less in comparison to conventional products, and the strength and the impact resistance have been increased remarkably.

There, however, is a problem with ITO-based electroconductive films in that the substitution of glass substrates with plastic films results in a decrease in adhesiveness, making a substrate and a formed electroconductive film prone to separate from each other. Moreover, metallic materials, such as ITO, require the use of an expensive production apparatus because they are formed into a film by using a vapor phase method such as sputtering.

Electroconductive polymers are known as an electroconductive material which substitutes for such conventional materials. The use of an electroconductive polymer makes it possible to form a thin film which exhibits develop electric conductivity by coating, resulting in an advantage that such a film may be produced at low cost. Moreover, an electrode made of an electroconductive polymer is more flexible and less brittle than ITO electrodes, and it therefore is less prone to break even if it is used in flexible items. For this reason, it also has an advantage that it may extend the lifetime of devices if an electrode made of an electroconductive polymer is used in a touch screen, which requires a particularly highly flexible electrode.

However, it is known that it is difficult to disperse an electroconductive polymer in a solvent, and the film formed by using a coating liquid containing an electroconductive polymer, lacks uniformity. Thus, a polythiophene doped with a polyanion has been developed (disclosed in the specification of European Patent No. 440957), and in particular, a polyethylene dioxythiophene/polystyrene sulfonic acid (PEDOT/PSS) having the structure shown below, which uses 3,4-ethylenedioxy-polythiophene (PEDOT) as the polythiophene and uses poly(styrene sulfonic acid) (PSS) as the polyanion, is being applied in a wide variety of applications.

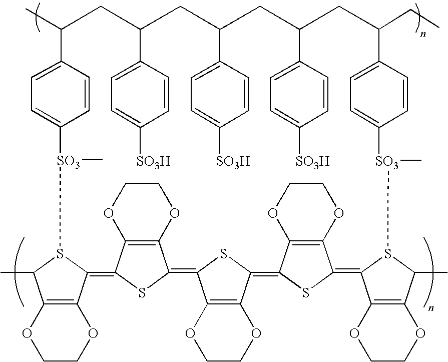

The PEDOT/PSS, in which PEDOT is doped with poly(styrene sulfonic acid), has enhanced dispersibility in water, and thus is considered to have excellent coating performance.

Furthermore, researches are being conducted to increase the electroconductivity of electrodes produced using the aqueous solutions of PEDOT-based polymers. For example, a method of using a mixed solvent of a polyhydric alcohol, a monohydric alcohol, and an amide-based or sulfoxide-based solvent, has been proposed in Japanese Patent Application National Publication (Laid-Open) No. 2007-531233.

It is also reported in JP-A No. 2007-531233 that a PEDOT-based composition added with a water-soluble organic compound such as ethylene glycol and a water-soluble epoxy monomer, may form an electroconductive film excellent in transparency, electroconductivity and water resistance.

### SUMMARY OF THE INVENTION

According to a first aspect of the present invention, there is provided an organic electroconductive polymer coating liquid including an electroconductive polymer and a dopant, which are dispersed in at least one selected from a monohydric alcohol, a ketone or water, in which the average value of a dispersed particle diameter of the electroconductive polymer and the dopant is 50 nm or less, and the viscosity of the coating liquid is 6.0 mPa·s or less.

According to a second aspect of the present invention, there is provided an organic electroconductive polymer film formed by application of the organic electroconductive polymer coating liquid according to the first aspect, and drying the coating liquid.

According to a third aspect of the present invention, there is provided an electric conductor having the organic electroconductive polymer film according to the second aspect provided on a support.

According to a fourth aspect of the present invention, there is provided a resistive film touch panel including: a first electric conductor having an electroconductive film on a transparent film that is a support, and a second electric conductor having an electroconductive film on a substrate that is a support, provided such that the electroconductive films of the first electric conductor and the second electric conductor are opposed to each other, in which at least one electroconductive film of the first electric conductor and the second electric conductor is the organic electroconductive polymer film according to the second aspect.

### BRIEF DESCRIPTION OF THE DRAWING

FIG. 1 is a schematic cross-sectional view that explains an exemplary resistive film touch panel of the present invention.

### DETAILED DESCRIPTION OF THE INVENTION

Hereinafter, the present invention will be described in detail. The denotation “to” in this specification means the numerals before and after “to”, both inclusive as the minimum value and the maximum value, respectively.

<Organic Electroconductive Polymer Coating Liquid>

Electroconductive polymer dispersions having enhanced dispersibility may now be obtained due to the technologies described above, however in some cases, the dispersibility is still insufficient. Therefore, it is desired to further decrease the in-plane fluctuation of surface resistance of the formed electroconductive films.

Particularly, when an electroconductive film is applied to a touch panel, the in-plane fluctuation of surface resistance directly exerts influence on the linearity of the internal resistance value with respect to the positional variant.

Under such circumstances, the present inventors devotedly conducted research, and unexpectedly found that the in-plane fluctuation of surface resistance is markedly suppressed by selecting particular solvent species, and adjusting dispersed particle diameter and viscosity. Thus, the present inventors further carried out an investigation based on this finding, and finally completed the present invention.

In the organic electroconductive polymer coating liquid of the present invention, an electroconductive polymer and a dopant are dispersed in at least one selected from a monohydric alcohol, a ketone or water. The viscosity of this dispersion is 6.0 mPa·s or less, and the dispersed particle diameter of the electroconductive polymer and the dopant included in this dispersion is 50 nm or less.

Hereinafter, the constitution of the organic electroconductive polymer coating liquid will be described in detail.

(1) Electroconductive Polymer

The electroconductive polymer to be used for the present invention refers to a polymer which exhibits an electrical conductivity of 10⁻⁶ S·cm⁻¹ or more. Any polymer corresponding to the above may be used. More preferred is a polymer having an electrical conductivity of 10⁻¹ S·cm⁻¹ or more.

The electroconductive polymer is preferably a non-conjugated polymer or conjugated polymer made up of aromatic carbon rings or aromatic heterocycles linked by single bonds or divalent or multivalent linking groups.

The aromatic carbon rings in the non-conjugated polymer or conjugated polymer is, for example, a benzene ring and also may be formed a fused ring.

The aromatic heterocycle in the non-conjugated polymer or conjugated polymer is, for example, a pyridine ring, a pyrazine ring, a pyrimidine ring, a pyridazine ring, a triazine ring, an oxazole ring, a thiazole ring, an imidazole ring, an oxadiazole ring, a thiadiazole ring, a triazole ring, a tetrazole ring, a furan ring, a thiophene ring, a pyrrole ring, an indole ring, a carbazole ring, a benzimidazole ring, an imidazopyridine ring, or the like. It also may be formed a fused ring and may have a substituent.

Examples of the divalent or multivalent linking group in a non-conjugated polymer or conjugated polymer may include linking groups formed by a carbon atom, a silicon atom, a nitrogen atom, a boron atom, an oxygen atom, a sulfur atom, a metal, a metal ion, or the like. Preferred are a carbon atom, a nitrogen atom, a silicon atom, a boron atom, an oxygen atom, a sulfur atom, and a group formed of a combination thereof. Examples of such a group formed of a combination may include a methylene group, a carbonyl group, an imino group, a sulfonyl group, a sulfinyl group, an ester group, an amide group and a silyl group, which are either substituted or unsubstituted.

Specific examples of the electroconductive polymer may include polyaniline, poly(para-phenylene), poly(para-phenylenevinylene), polythiophene, polyfuran, polypyrrole, polyselenophene, polyisothianaphthene, polyphenylene sulfide, polyacethylene, polypyridylvinylene and polyazine, which are electroconductive and are either substituted or non-substituted. These may be used either singly or, according to the purpose, in combination of two or more kinds thereof.

If a desired electrical conductivity is achieved, it may be used in the form of a mixture with another polymer having no electrical conductivity, and copolymers of such monomers with other monomers having no electrical conductivity may also be used.

The electroconductive polymer is preferably a conjugated polymer. Examples of such a conjugated polymer may include polyacethylene, polydiacetylene, poly(para-phenylene), polyfluorene, polyazulene, poly(paraphenylene sulfide), polypyrrole, polythiophene, polyisothianaphthene, polyaniline, poly(para-phenylenevinylene), poly(2,5-thienylenevinylene), multiple chain type conjugated polymers (polyperinaphthalene, an the like), metal phthalocyanine-type polymers, and other conjugated polymers [poly(para-xylylene), poly[α-(5,5′-bithiophenediyl)benzylidene and the like], and the like.

Preferred are poly(para-phenylene), polypyrrole, polythiophene, polyaniline, poly(para-phenylenevinylene) and poly(2,5-thienylenevinylene). More preferred are poly(para-phenylene), polythiophene and poly(para-phenylenevinylene).

Such conjugated polymers may have a substituent, examples of the substituent may include substituents which are described as R¹¹ in Formula (I) given below.

In the present invention, it is preferable, from the viewpoint of compatibility of high transparency and high electrical conductivity, particularly that the electroconductive polymers have a partial structure represented by the following Formula (I) (in other words, that it be polythiophene or its derivative). In the present invention, ‘transparency’ means that the transmittance at a wavelength of 550 nm, which is visible light, is 50% or more. The transmittance of the obtained electroconductive film is preferably 60% or more, and more preferably 70% or more.

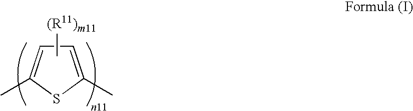

In Formula (I), R¹¹ represents a substituent; and m11 is an integer of from 0 to 2. When m11 represents 2, the R¹¹s may be either the same or different and also may be linked each other to form a ring. n¹¹ is an integer of 1 or greater.

The substituent represented by R¹¹ includes alkyl groups (preferably having 1 to 20 carbon atoms, more preferably having 1 to 12 carbon atoms, and still more preferably having 1 to 8 carbon atoms; for example, methyl, ethyl, isopropyl, tert-butyl, n-octyl, n-decyl, n-hexadecyl, cyclopropyl, cyclopentyl and, cyclohexyl), alkenyl groups (preferably having 2 to 20 carbon atoms, more preferably having 2 to 12 carbon atoms, and still more preferably having 2 to 8 carbon atoms; for example, vinyl, allyl, 2-butenyl, 3-pentenyl, 2-hexenyl, 3-hexenyl, 4-hexenyl and 2-octenyl), alkynyl groups (preferably having 2 to 20 carbon atoms, more preferably having 2 to 12 carbon atoms, and still more preferably having 2 to 8 carbon atoms; for example, propargyl and 3-pentynyl), aryl groups (preferably having 6 to 30 carbon atoms, more preferably having 6 to 20 carbon atoms, and still more preferably having 6 to 12 carbon atoms; for example, phenyl, p-methylphenyl and naphthyl), amino group (preferably having 0 to 20 carbon atoms, more preferably having 0 to 10 carbon atoms, and still more preferably having 0 to 6 carbon atoms; for example, amino, methylamino, dimethylamino, diethylamino, dibenzylamino, and diphenylamino),

alkoxy groups (preferably having 1 to 20 carbon atoms, more preferably having 1 to 12 carbon atoms, and still more preferably having 1 to 8 carbon atoms; for example, methoxy, ethoxy, butoxy, hexyloxy and octyloxy), aryloxy groups (preferably having 6 to 20 carbon atoms, more preferably having 6 to 16 carbon atoms, and still more preferably having 6 to 12 carbon atoms; for example, phenyloxy and 2-naphthyloxy), acyl groups (preferably having 1 to 20 carbon atoms, more preferably having 1 to 16 carbon atoms, and still more preferably having 1 to 12 carbon atoms; for example, acetyl, benzoyl, formyl and pivaloyl), alkoxycarbonyl groups (preferably having 2 to 20 carbon atoms, more preferably having 2 to 16 carbon atoms, and still more preferably having 2 to 12 carbon atoms; for example, methoxycarbonyl and ethoxycarbonyl), aryloxycarbonyl groups (preferably having 7 to 20 carbon atoms, more preferably having 7 to 16 carbon atoms, and still more preferably having 7 to 10 carbon atoms; for example, phenyloxycarbonyl),

acyloxy group (preferably having 2 to 20 carbon atoms, more preferably having 2 to 16 carbon atoms, and still more preferably having 2 to 10 carbon atoms; for example, acetoxy and benzoyloxy), acylamino groups (preferably having 2 to 20 carbon atoms, more preferably having 2 to 16 carbon atoms, and still more preferably having 2 to 10 carbon atoms; for example, acetylamino and benzoylamino), alkoxycarbonylamino groups (preferably having 2 to 20 carbon atoms, more preferably having 2 to 16 carbon atoms, and still more preferably having 2 to 12 carbon atoms; for example, methoxycarbonylamino), aryloxycarbonylamino groups (preferably having 7 to 20 carbon atoms, more preferably having 7 to 16 carbon atoms, and still more preferably having 7 to 12 carbon atoms; for example, phenyloxycarbonylamino), sulfonylamino groups (preferably having 1 to 20 carbon atoms, more preferably having 1 to 16 carbon atoms, and still more preferably having 1 to 12 carbon atoms; for example, methanesulfonylamino and benzenesulfonylamino), a sulfamoyl group (preferably having 0 to 20 carbon atoms, more preferably having 0 to 16 carbon atoms, and still more preferably having 0 to 12 carbon atoms; for example, sulfamoyl, methylsulfamoyl, dimethylsulfamoyl and phenylsulfamoyl),

carbamoyl groups (preferably having 1 to 20 carbon atoms, more preferably having 1 to 16 carbon atoms, and still more preferably having 1 to 12 carbon atoms; for example, carbamoyl, methylcarbamoyl, diethylcarbamoyl and phenylcarbamoyl), alkylthio groups (preferably having 1 to 20 carbon atoms, more preferably having 1 to 16 carbon atoms, and still more preferably having 1 to 12 carbon atoms; for example, methylthio and ethylthio), arylthio groups (preferably having 6 to 20 carbon atoms, more preferably having 6 to 16 carbon atoms, and still more preferably having 6 to 12 carbon atoms; for example, phenylthio), sulfonyl groups (preferably having 1 to 20 carbon atoms, more preferably having 1 to 16 carbon atoms, and still more preferably having 1 to 12 carbon atoms; for example, mesyl and tosyl), sulfinyl groups (preferably having 1 to 20 carbon atoms, more preferably having 1 to 16 carbon atoms, and still more preferably having 1 to 12 carbon atoms; for example, methanesulfinyl and benzenesulfinyl), ureido groups (preferably having 1 to 20 carbon atoms, more preferably having 1 to 16 carbon atoms, and still more preferably having 1 to 12 carbon atoms; for example, ureido, methylureido and phenylureido), phosphoamide groups (preferably having 1 to 20 carbon atoms, more preferably having 1 to 16 carbon atoms, and still more preferably having 1 to 12 carbon atoms; for example, diethyl phosphoamide and phenyl phosphoamide),

a hydroxy group, a mercapto group, halogen atoms (for example, fluorine atom, chlorine atom, bromine atom and iodine atom), a cyano group, a sulfo group, a carboxyl group, a nitro group, a hydroxamic acid group, a sulfino group, a hydrazino group, an imino group, heterocyclic groups (preferably having 1 to 20 carbon atoms and more preferably having 1 to 12 carbon atoms; examples of hetero atoms may include a nitrogen atom, an oxygen atom and a sulfur atom; specific examples may include pyrrolidine, piperidine, piperazine, morpholine, thiophene, furan, pyrrole, imidazole, pyrazole, pyridine, pyrazine, pyridazine, triazole, triazine, indole, indazole, purine, thiazoline, thiazole, thiadiazole, oxazoline, oxazole, oxadiazole, quinoline, isoquinoline, phthalazine, naphthylydine, quinoxaline, quinazoline, cinnoline, pteridine, acridine, phenanthroline, phenazine, tetrazole, benzimidazole, benzoxazole, benzthiazole, benzotriazole and tetraazaindene), and silyl groups (preferably having 3 to 40 carbon atoms, more preferably having 3 to 30 carbon atoms, and still more preferably having 3 to 24 carbon atoms; for example, trimethylsilyl and triphenylsilyl).

The substituent represented by R¹¹ may be additionally substituted. When it has a plural substituents, they may be either the same or different and may, if possible, be linked together to form a ring. Examples of the ring to be formed may include a cycloalkyl ring, a benzene ring, a thiophene ring, a dioxane ring and a dithiane ring.

The substituent represented by R¹¹ is preferably an alkyl group, an alkenyl group, an alkynyl group, an alkoxy group and an alkylthio group, and more preferably an alkyl group, an alkoxy group and an alkylthio group. In still more preferably, when m11 is 2, two R¹¹s are alkoxy groups or alkylthio groups forming a ring, and it is preferable to form a dioxane ring or a dithiane ring.

When m11 is 1 in Formula (1), R¹¹ is preferably an alkyl group, and more preferably an alkyl group having 2 to 8 carbon atoms.

When Formula (1) is poly(3-alkylthiophene) that R¹¹ is an alkyl group, the linkage mode between the adjacent thiophene rings includes a sterically regular mode in which all thiophene rings are linked by 2-5′ and a sterically irregular mode which contains 2-2′ linkages and 5-5′ linkages. Among them, the sterically irregular mode is preferred.

In the present invention, it is particularly preferable, from the viewpoint of achieving both high transparency and high electrical conductivity, that the electroconductive polymer is 3,4-ethylenedioxy-polythiophene, which is specific example compound (6) shown below.

The polythiophene represented by Formula (1) and derivatives thereof may be prepared by known methods such as those disclosed in J. Mater. Chem., 15, 2077-2088 (2005) and Advanced Materials, 12(7), 481 (2000). For examples, Denatron P502 (manufactured by NAGASE CHEMICAL CO., LTD.), 3,4-ethylenedioxythiophene (CLEVIOS M V2), and 3,4-polyethylenedioxythiopene/polystyrenesulfonate (CLEVIOS P), CLEVIOS C, CLEVIOS F E, CLEVIOS M V2, CLEVIOS P, CLEVIOS P AG, CLEVIOS P HC V4, CLEVIOS P HS, CLEVIOS PH, CLEVIOS PH 500, CLEVIOS PH 510,CLEVIOS PH 750 and CLEVIOS PH 1000) (all the CLEVIOS s are manufactured by H.C. Starck GmbH), and ORGACON S-300 (manufactured by Agfa-Gevaert Japan LTD.) may be obtained as commercial products.

A polyaniline (manufactured by Aldrich Chemical Company, Inc.), a polyaniline (ereraldine (phonetic) base) (manufactured by Aldrich Chemical Company, Inc.), or the like are available as polyaniline or derivatives thereof.

A polypyrrole (manufactured by Aldrich Chemical Company, Inc.) or the like are available as polypyrrole or derivatives thereof.

Specific examples of an electroconductive polymer are shown below, but the present invention is not limited to them. Besides these, compounds disclosed in W098/01909 and so on are also provided as examples.

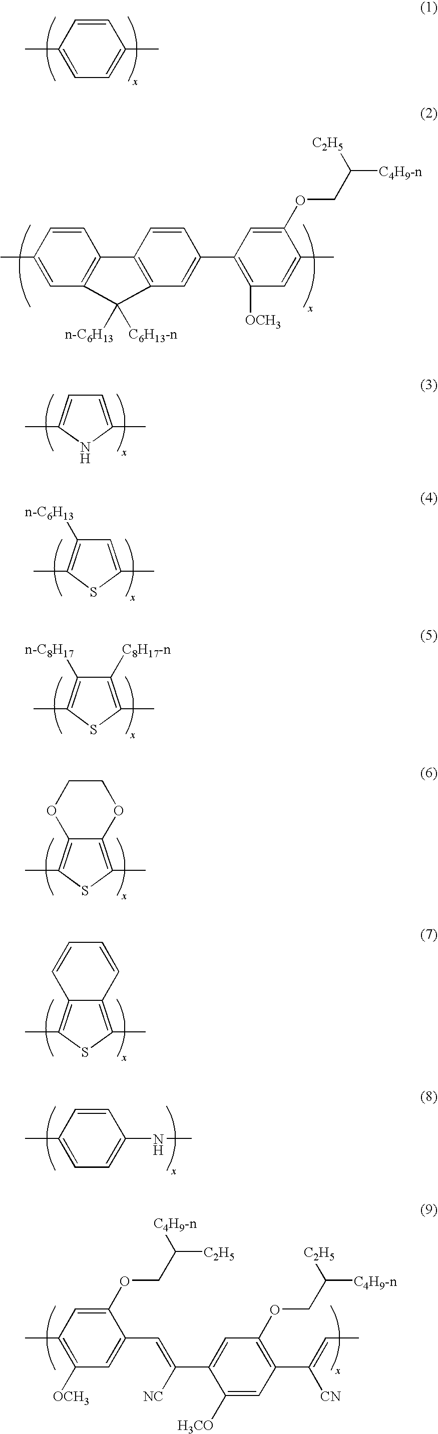

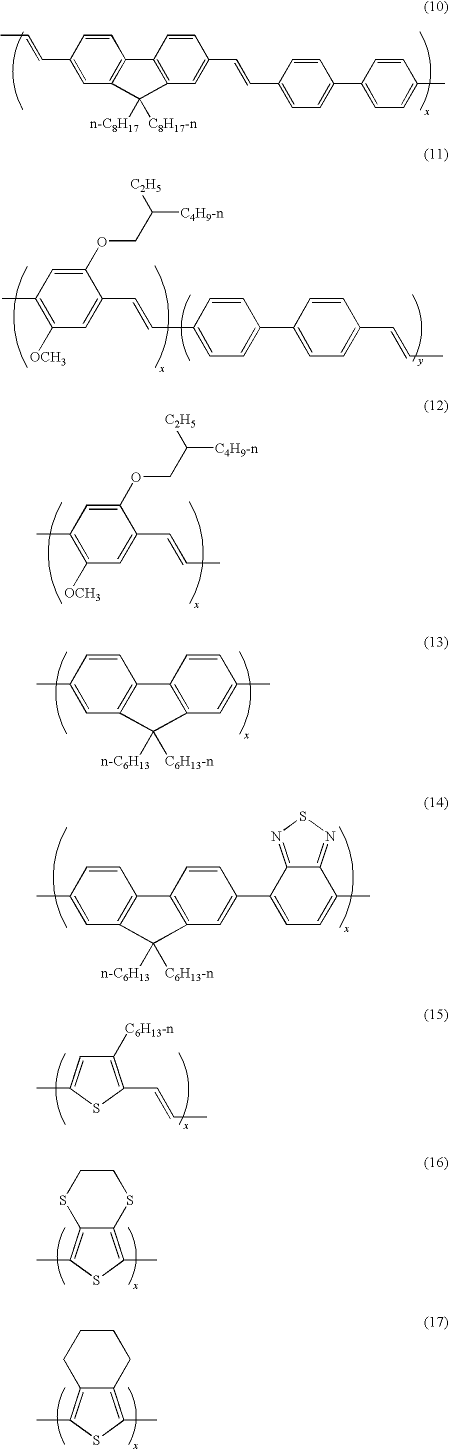

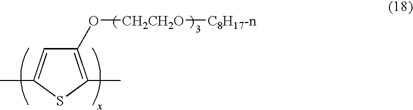

The weight average molecular weight of an electroconductive polymer to be used in the present invention is preferably from 1,000 to 1,000,000, more preferably from 10,000 to 500,000, and still more preferably from 10,000 to 100,000. Here, the weight average molecular weight refers to the weight average molecular weight measured by gel permeation chromatography relative to polystyrene standards.

(2) Dopant

The organic electroconductive polymer coating liquid of the present invention contains at least one dopant. As the coating liquid contains a dopant, the coating liquid becomes a dispersion (composition) having satisfactory dispersibility, and the electroconductivity of the obtainable electroconductive film may be increased.

The dopant as used herein means an additive which has an action of changing the electrical conductivity of an electroconductive polymer. Such dopants include electron-accepting (i.e., acceptor) dopants and electron-donating (i.e., donor) dopants.

Examples of electron-accepting (i.e., acceptor) dopants may include halogens (Cl₂, Br₂, I₂, ICl, ICl₃, IBr, IF), Lewis acids (PF₅, AsF₅, SbF₅, BF₃, BCl₃, BBr₃, SO₃), proton acids (HF, HCl, HNO₃, H₂SO₄, HClO₄, FSO₃H, CISO₃H, CF₃SO₃H, various organic acids, amino acids, and the like), transition metal compounds (FeCl₃, FeOCl, TiCl₄, ZrCl₄, HfCl₄, NbF₅, NbCl₅, TaCl₅, MoF₅, MoCl₅, WF₆, WCl₆, UF₆, LnCl₃ (Ln is lanthanide, such as La, Ce, Pr, Nd, and Sm), electrolyte anions (Cl⁻, Br⁻, I⁻, PF₆⁻, AsF₆⁻, SbF₆⁻, BF₄⁻, various sulfonate anions), and others (O₂, XeOF₄ (NO₂⁺)(SbF₆⁻), (NO₂⁺)(SbCl₆⁻), (NO₂⁺)(BF₄⁻), FSO₂OOSO₂F, AgClO₄, H₂IrCl₆ and La(NO₃)₃.6H₂O and the like).

Examples of electron-donating (i.e., donor) dopants may include alkali metals (Li, Na, K, Rb, Cs), alkaline earth metals (Ca, Sr, Ba), lanthanides (Eu, or the like), and others (R₄N⁺, R₄P⁺, R₄As⁺, R₃S⁺, acetylcholine).

When a dopant is a water-soluble polymer, it is possible to form an organic electroconductive polymer coating liquid as a aqueous dispersion liquid, whereby the environmental burden is reduced and it is possible to form easily electroconductive thin film by coating.

Examples of the combination of the dopant and the electroconductive polymer may include:
(A) polyacethylene with I₂, AsF₅, FeCl₃ or the like;
(B) poly(p-phenylene) with AsF₅, K, AsF₆⁻ or the like;
(C) polypyrrole with ClO₄⁻ or the like;
(D) polythiophene with ClO₄⁻, or a sulfonic acid compound, especially polystyrene sulfonic acid, a nitrosonium salt, an aminium salt, a quinone, or the like;
(E) polyisothianaphthene with I₂ or the like;
(F) poly(p-phenylene sulfide) with AsF₅;
(G) poly(p-phenyleneoxide) with AsF₅;
(H) polyaniline with HCl or the like;
(I) poly(p-phenylenevinylene) with H₂SO₄ or the like;
(J) polythiophenylenevinylene with I₂ or the like;
(K) nickel phthalocyanine with I₂.

Among these combinations, preferred is the combination (D) or (H), more preferred, from the viewpoint that the dope condition is high in stability, is the combination of polythiophenes (polythiophene or its derivative) with a sulfone compound, and still more preferred, from the viewpoint that the aqueous dispersion liquid may be prepared whereby an electroconductive thin film may be prepared easily by coating, is the combination of polythiophenes with polystyrene sulfonic acid and/or a copolymer of styrene sulfonic acid,.

In order to improve the dispersibility of an electroconductive polymer, an ion-conductive polymer in which polymer chain has been doped with an electrolyte may be used. Examples of such a polymer chain may include polyethers (polyethylene oxide, polypropylene oxide, and the like), polyesters (polyethylene succinate, poly-β-propiolactone, and the like), polyamines (polyethyleneimine, and the like), and polysulfides (polyalkylene sulfide, and the like). The electrolyte doped may include various alkali metal salts.

Examples of the alkali metal ion which constitutes the alkali metal salt may include Li⁺, Na⁺, K⁺, Rb⁺ and Cs⁺. Examples of the anion which forms the counter salt may include F⁻, Cl⁻, Br⁻, NO₃⁻, SCN⁻, ClO₄⁻, CF₃SO₃⁻, BF₄⁻, AsF₆⁻ and BPh₄⁻.

Examples of the combination of the polymer chain and the alkali metal salt may include polyethylene oxide with LiCF₃SO₃, LiClO₄ or the like, polyethylene succinate with LiClO₄, LiBF₄, poly-β-propiolactone with LiClO₄ or the like, polyethyleneimine with NaCF₃SO₃, LiBF₄ or the like, and polyalkylene sulfide with AgNO₃ or the like.

The ratio of the electroconductive polymer and the dopant (electroconductive polymer:dopant) may be of any value. From the viewpoint of balancing between the stability of the doped state and electroconductivity, the ratio by mass is preferably in the range of from 1.0:0.0000001 to 1.0:10, more preferably in the range of from 1.0:0.00001 to 1.0:1.0, and even more preferably in the range of from 1.0:0.0001 to 1.0:0.5.

From the viewpoints of adjusting the viscosity of the dispersion containing the electroconductive polymer and the dopant, and preventing aggregation of the dispersion of the electroconductive polymer and the dopant, the total solid concentration of the electroconductive polymer and the dopant is preferably from 0.05% by mass to 1.5% by mass, more preferably from 0.2% by mass to 1.2% by mass, even more preferably from 0.2% by mass to 0.7% by mass, and still more preferably from 0.3% by mass to 0.5% by mass.

The total solid concentration of the electroconductive polymer and the dopant is defined as the value measured on the basis of the ratio of the dopant and the weight of the solid fraction extracted and dried from the dispersion with regard to the weight of the dispersion containing the electroconductive polymer.

(3) Solvent

The organic electroconductive polymer coating liquid of the present invention contains at least one selected from a monohydric alcohol, a ketone or water.

The monohydric alcohol is preferably a monohydric alcohol having 1 to 3 carbon atoms from the viewpoint of viscosity, and more preferably methanol having one carbon atom or ethanol having two carbon atoms. Methanol and ethanol may be used singly, or may be used in combination.

The ketone is preferably a ketone having 3 to 9 carbon atoms from the viewpoint of viscosity, and more preferably acetone, methyl ethyl ketone or diethyl ketone, which are ketones having 3 to 5 carbon atoms. These ketones may be used singly, or may be used in combination.

Among the monohydric alcohols and the ketones, it is more preferable to use methanol.

The monohydric alcohol, ketone and water may be used singly alone, or may be used in combination of two or more species. The combination in the case of using two species together is not particularly limited, and the combination of water and methanol, and the combination of water, methanol and methyl ethyl ketone are preferable.

The organic electroconductive polymer coating liquid of the present invention may also contain a solvent other than the monohydric alcohol, ketone and water, but it is preferable that the coating liquid contain a monohydric alcohol, a ketone and/or water as the main component solvent. Specifically, the content of the monohydric alcohol, ketone and/or water in the organic electroconductive polymer coating liquid is preferably from 85% by mass to 99.9% by mass, and more preferably from 90% by mass to 99% by mass.

Furthermore, it is preferable that the organic electroconductive polymer coating liquid of the present invention contain a polyhydric alcohol for enhancing the electrical conductivity.

The polyhydric alcohol preferably has 2 to 12 carbon atoms, and more preferably 2 to 8 carbon atoms, from the viewpoints of the solubility in water/monohydric alcohol/ketone and the viscosity.

Specific examples of the polyhydric alcohol may include ethylene glycol, propylene glycol, diethylene glycol, triethylene glycol, tetraethylene glycol, glycerin, sugars (fructose and the like), hydroquinone, gallic acid, catechol, and the like. It is more preferable to use ethylene glycol, propylene glycol, diethylene glycol, triethylene glycol, or tetraethylene glycol, and it is even more preferable to use ethylene glycol, for the solubility in water or the viscosity.

The content of the polyhydric alcohol in the organic electroconductive polymer coating liquid is preferably from 0.5% by mass to 20% by mass, more preferably from 1% by mass to 10% by mass, and even more preferably from 1% by mass to 5% by mass.

The content ratio of the electroconductive polymer and the polyhydric alcohol (electroconductive polymer:polyhydric alcohol) may be of any value, and from the viewpoint of balancing between the cost and the electroconductivity, the ratio of by mass preferably in the range of 1:400 to 1:0.35, more preferably in the range of 1:200 to 1:1, and even more preferably in the range of 1:50 to 1:5.

Examples of the solvent that may be used in combination in addition to the monohydric alcohol, ketone, water and polyhydric alcohol, include toluene, hexane, xylene, N-methyl-2-pyrrolidone, N,N-dimethyl acetamide, N,N-dimethyl formamide, ethyl acetate, butyl acetate, but in a desirable case, the organic electroconductive polymer coating liquid does not substantially contain any solvent other than the monohydric alcohol, ketone, water and polyhydric alcohol.

(4) Other Additives

Additives that will be described later may be further added to the organic electroconductive polymer coating liquid of the present invention. Examples of the additives that may be further incorporated may include inorganic fine particles, polymer fine particles or a silane coupling agent for the purpose of increasing the film strength; a surfactant, particularly a nonionic surfactant, for the purpose of stably dispersing the dispersed particles or increasing the wettability to the substrate; a fluorine-containing compound, particularly a fluorine-containing nonionic surfactant, for the purpose of decreasing the refractive index and increasing transparency; and the like.

When a nonionic surfactant is added thereto, it is presumed that the wettability with respect to the support is improved and, since pH of the PEDOT/PSS dispersion is not changed, PEDOT/PSS is prevented from aggregating, whereby a smoother coating film face can be formed. In addition, in a fluorine-containing nonionic surfactant, it is presumed that haze is reduced and high transmittance can be achieved due to the refractive index-lowering effect caused by the fluorine group as well as due to the suppression of aggregation.

Specific examples of the nonionic surfactant may include TRITON X-114, -100, -100CG, -102, -165, N-60, -101, -111, -115, TERGITOL 15-S-7, -12, and -15 (trade names, manufactured by Dow Chemical Company), and specific examples of the fluorine-containing surfactant may include ZONYL FS-300, FSO, and FSO-100 (trade names, manufactured by DuPont Company).

An additive may also be added to the organic electroconductive polymer coating liquid of the present invention for the purpose of increasing durability. Examples of such an additive may include hydroxy compounds, phenol compounds, amine compounds, phosphoric acid compounds, phosphorous acid ester compounds, sulfonic acid compounds, phosphorus compounds, hydroxylamine compounds, hydroxamic acid compounds, and the like. These additives may be low molecular weight compounds or polymeric compounds. Examples of the polymeric compounds may include polyvinyl alcohol, polyesters and the like.

Even among the compounds, phosphoric acid compounds, phosphorous acid ester compounds, hydroxylamine compounds, and hydroxamic acid compounds are preferable, and hydroxamic acid derivatives or phosphoric acid derivatives are more preferable.

The ratio of the aforementioned additive such as a hydroxamic acid derivative, and the electroconductive polymer (additive:electroconductive polymer) may be of any value, but from the viewpoint of balancing between high electroconductivity and high durability, the ratio by mass is preferably in the range of from 0.00001:1.0 to 1000:1, more preferably in the range of from 0.0001:1.0 to 500:1, and even more preferably in the range of from 0.0005:1.0 to 100:1.

The method of adding the additive may be in any manner. A preferable method is a method in which a dispersion containing an electroconductive polymer and a solution prepared by dissolving the additive are mixed.

(5) Method for Preparing Organic Electroconductive Polymer Coating Liquid

In regard to the method of dispersing the electroconductive polymer in the solvent, known methods may be applied. Examples of the methods may include dispersion methods such as a jaw crusher method, an ultracentrifugal mill method, a cutting mill method, an automated mortar method, a disk mill method, a ball mill method, and an ultrasonic dispersion method.

(6) Properties of Organic Electroconductive Polymer Coating Liquid

In the organic electroconductive polymer coating liquid, the dopant is doped into the electroconductive polymer to form composite particles, and these composite particles exist in the form of dispersed particles. For example, when the electroconductive polymer is PEDOT and the dopant is PSS, the complex particles exist in the form of dispersed particles in which PEDOT is entangled with the PSS polymer chains.

The average value of the dispersed particle diameter resulting from this electroconductive polymer and dopant is 50 nm or less. As long as the production is possible, there is no limit on the lower limit value of the dispersed particle diameter. Preferably, the average value of the dispersed particle diameter is 30 nm or less, preferably from 10 nm to 30 nm, and more preferably from 20 nm to 30 nm.

The dispersed particle diameter is measured according to a centrifugal sedimentation method. A dispersion having a solid concentration of from 0.005% by mass to 1.5% by mass is measured 5 times to 10 times, and the 50 cumulative volume % of particle diameters is taken as the representative value.

In the organic electroconductive polymer film formed by applying the organic electroconductive polymer coating liquid of the present invention and drying the coating liquid, a sea-island structure is formed by the dispersed particles. Therefore, when this sea-island structure is observed with an atomic force microscope (AFM) or the like, the size of the dispersed particles contained in the coating liquid can be roughly estimated.

In regard to the organic electroconductive polymer coating liquid of the present invention, the average value of the size of the dispersed particles formed by the electroconductive polymer and the dopant is 50 nm or less, and the viscosity of the coating liquid in that case is 6.0 mPa·s or less. This balance between the dispersed particle diameter and the viscosity of the coating liquid leads to a remarkable decrease in the in-plane fluctuation of surface resistance of the obtainable electroconductive film.

The viscosity of the organic electroconductive polymer coating liquid is preferably from 1.0 mPa·s to 6.0 mPa·s, and more preferably from 2.0 mPa·s to 6.0 mPa·s.

The viscosity is measured with an oscillatory viscometer at 25° C.

It is desirable to prepare the organic electroconductive polymer coating liquid adjusting a pH value in order to stabilize the dispersed particles. For example, when the electroconductive polymer is PEDOT and the dopant is PSS, it is desirable to adjust the pH of from 1.0 to 3.0, more desirably from 1.5 to 3.0, and even more desirably from 2.0 to 2.5.

The obtained organic electroconductive polymer coating liquid is applied to form an organic electroconductive polymer film. Examples of an application method may include known application methods such as extrusion die coater, air-doctor coater, blade coater, rod coater, knife coater, squeeze coater, reverse-roll coater and bar coater.

In the case where a film such as the electroconductive polymer film is formed by two layers or more, each layer may be applied and dried repeatedly, or two layers or more may be formed by simultaneous multilayer coating. Simultaneous multilayer coating is preferable from the viewpoint of decreasing production costs and the shortening production time. Here, ‘simultaneous multilayer coating’ signifies that two coating solutions are applied in a contact condition.

The above-mentioned simultaneous multilayer coating may be performed by curtain coater, slide coater, extrusion coater, or the like, preferably curtain coater among them.

The speed of coating in the case of using a bar coater is preferably from 1 m/min to 30 m/min, more preferably from 3 m/min to 20 m/min, and even more preferably from 5 m/min to 20 m/min.

As such, when the organic electroconductive polymer coating liquid of the present invention is used, there is another advantage that high speed coating may be achieved.

The thickness of the organic electroconductive polymer film is preferably in the range of from 1 nm to 2 μm, and more preferably in the range of from 10 nm to 1 μm. When the thickness of the organic electroconductive polymer film is within this range, sufficient electroconductivity and transparency may be obtained.

The thickness of the organic electroconductive polymer film is defined as the value measured by observing the cross-section at a magnification of 200,000 times using a transmission electron microscope (trade name: JEM2010, manufactured by JEOL, Ltd.).

The surface resistance at 25° C. and 50% RH of the organic electroconductive polymer film is preferably in the range of from 100 Ω/sq to 3,000 Ω/sq from the viewpoint of the usages as an electroconductive film, and is more preferably in the range of from 500 Ω/sq to 3,000 Ω/sq.

In regard to the organic electroconductive polymer film, CV value which is in-plane fluctuation of the surface resistance at 25° C. and 50% RH and is represented by the following expression, is preferably from 0% to less than 5.0%, and more preferably from 0% to 3.0%. Here, the CV value of the aforementioned range is realized by using the organic electroconductive polymer coating liquid of the present invention.

CV value=(standard deviation of surface resistance)/(average value of surface resistance)×100

Here, the surface resistance is measured as follows.

For example, the obtained organic electroconductive polymer film is cut to a size of 80 mm×120 mm, and the surface resistance is measured at 28 points of measurement site, using a surface resistance meter (trade name: LORESTA GP Model MC-T610, manufactured by Mitsubishi Chemical Corp.), by moving the measuring probe as an ASP at a pitch interval of 16 mm in the X direction and 15 mm in the Y direction.

The average value and the standard deviation are determined from the measured surface resistance values.

It is preferable to further contain a hydroxy compound, a phenol compound, an amine compound, a phosphoric acid compound, a phosphorous acid ester compound, a sulfonic acid compound, a phosphorus compound, a hydroxylamine compound or a hydroxamic acid compound to the organic electroconductive polymer film, from the viewpoint of increasing durability. These compounds may be low molecular weight compounds, or may be polymeric compounds. Examples of the polymer may include polyvinyl alcohols, polyesters and the like.

The aforementioned compounds such as a hydroxy compound may be added into the organic electroconductive polymer coating liquid as described above; or alternatively, an organic electroconductive polymer film is first formed, and then the compounds may be incorporated later to the obtained organic electroconductive polymer film.

Among the compounds such as a hydroxy compound, a phosphoric acid compound, a phosphorous acid ester compound, a hydroxylamine compound or a hydroxamic acid compound is preferable, and a hydroxamic acid derivative or a phosphoric acid derivative is more preferable.

The compounds such as a hydroxy compound may be used singly, or may be used in combination of two or more species.

It is preferable for the organic electroconductive polymer film to further laminate a dielectric layer thereon, from the viewpoint of suppressing an increase in the surface resistance under a high temperature and high humidity environment, or enhancing scratch resistance. The dielectric layer as used in the present invention refers to an electroconductive layer having higher surface resistance than the electroconductive polymer coating layer, or an insulating layer.

The dielectric layer contains a binder, and examples of the binder may include known resins such as polyvinyl alcohols, polyethylene oxides, polyacrylic acids, polymethyl methacrylates, polyacrylamides, polystyrenes, polystyrene sulfonic acid (salts), polyacrylamides, polyesters, polyurethanes, epoxy-based curable resins, polyimides, polysiloxanes, and polyolefins. Polyvinyl alcohols and epoxy-based curable resins are preferable; and polyfunctional epoxy-based curable resins are more preferable.

The epoxy-based curable resins include DENACOL EX-313, EX-314, EX-321, EX-421, EX-611, EX-614, EX-614B, EX-811, EX-821, EX-830, EX-832, EX-841, EX-851, EX-861, EX-911, EX-920, EX-931, EX-941 (trade names, manufactured by Nagase ChemteX Corp.), and the like.

The binder contained in the dielectric layer may be used singly, or may be used in combination of two or more species.

It is also preferable for the binder used in the dielectric layer to be an ionomer, for improving electrical conductivity because the ionomer functions as a dopant for an electroconductive polymer, or enhancing scratch resistance because the ionomer cross-links to form a hardening film.

Examples of the solvent include water, alcohol and ketone, and it is preferable to use water from the viewpoint of reducing the environmental burden.

In addition to those, the dielectric layer may also contain additives such as a surfactant, a thickening agent, fine particles and an antistatic agent, and it is preferable for the dielectric layer to contain these additives.

Examples of the surfactant that may be applied to the dielectric layer may include those known anionic, nonionic and cationic surfactants. Descriptions on the surfactants may be found in, for example, “Handbook of Surfactants” (edited by Ichiro Nishi, Ichiro Imai, and Masatake Kasai, issued by Sangyo Tosho Publishing Co., Ltd., 1960).

The amount of addition of the surfactant is preferably in the range of from 0.1 mg/m² to 30 mg/m², and more preferably from 0.2 mg/m² to 10 mg/m². When the amount of addition of the surfactant is within the range mentioned above, the occurrence of repellence is suppressed, and the surface state is improved.

It is preferable to add fine particles to the dielectric layer, from the viewpoint of enhancing sliding properties or adjusting the refractive index (enhancing permeability and transparency), and as for such fine particles, both organic and inorganic fine particles may be used.

For example, polymer fine particles formed from polystyrene, polymethyl methacrylate, a silicone resin, a benzoguanamine resin or the like; or inorganic fine particles formed from silica, calcium carbonate, magnesium oxide, magnesium carbonate or the like may be used.

Among these, polystyrene, polymethyl methacrylate or silica is preferable from the viewpoint of the effect of improving the sliding property or the cost.

Examples of the inorganic fine particles may include SNOWTEX CL, XL, XS and S (trade names, manufactured by Nissan Chemical Industries, Ltd.), AEROSIL OX-50, AEROSIL EG-50, AEROSIL OX-90, AEROSIL 130, AEROSIL 150 (trade names, manufactured by Nippon Aerosil Co., Ltd.), and the like.

The average particle diameter of the fine particles is preferably from 0.1 μm to 12 μm, and more preferably from 0.2 μm to 9 μm. When the average particle diameter of the fine particles is within the range mentioned above, the effect of improving sliding property is sufficiently exhibited, and the display properties of display devices also become excellent.

Here, the average particle diameter of the fine particles of the present invention refers to the average value of the particle diameter determined as follows: images of any arbitrary 50 fine particles are taken with a scanning electron microscope, and the diameter of a circle having the same area as that of a fine particle determined from the images is taken as the particle diameter.

The amount of addition of the fine particles may vary, depending on the average particle diameter, but the amount of addition is preferably from 0.1 mg/m² to 30 mg/m², and more preferably from 0.5 mg/m² to 20 mg/m². When the amount of addition of the fine particles is within the range mentioned above, the sliding property improving effect is sufficiently exhibited, a decrease in transparency is suppressed, and the display performances of display devices become excellent.

The dielectric layer may contain an antistatic agent, and this antistatic agent may be tin oxide, antimony-doped tin oxide, titanium oxide, zirconium oxide, zinc oxide, indium oxide, copper, silver, gold, platinum, a silver alloy or the like. From the viewpoints of transparency and durability, antimony-doped tin oxide is preferable.

It is also preferable to add a thickening agent in order to adjust the viscosity of the coating liquid for forming a dielectric layer. As for the thickening agent, a known water-soluble polymer or an aqueous dispersion of a polymer may be applied, and both natural-product polymers and synthetic polymers may be favorably used.

Examples of the water-soluble polymer may include, as natural-product polymers, starches (corn starch, starch and the like), seaweeds (agar, sodium alginate, and the like), plant adhesive substances (gum arabic, and the like), animal proteins (glue, casein, gelatin, egg white and the like), fermented adhesive substances (pullulan, dextrin and the like), and the like; as semi-synthetic polymers, starchy substances (soluble starch, carboxyl starch, dextran and the like), and celluloses (viscose, methylcellulose, ethylcellulose, carboxymethylcellulose, hydroxyethylcellulose, hydroxypropylcellulose, hydroxypropylmethylcellulose, and the like); synthetic polymers (polyvinyl alcohol, polyacrylamide, polyvinylpyrrolidone, polyethylene glycol, polypropylene glycol, polyvinyl ether, polyethyleneimine, polystyrene sulfonic acid or copolymers thereof, polyvinylsulfonic acid or copolymers hereof, polyacrylic acid or copolymers thereof, acrylic acid or copolymers thereof, maleic acid copolymers, maleic acid monoester copolymers, acryloylmethylpropanesulfonic acid or copolymers thereof, and the like); and the like.

Examples of the aqueous dispersion of a polymer may include aqueous dispersions of acrylic polymers, aqueous dispersions of synthetic rubber-based polymers (for example, styrene-butadiene copolymer), aqueous dispersions of polyether-based polymers, aqueous dispersions of polyurethane-based polymers, and the like.

The average film thickness of the dielectric layer is preferably from 0.05 nm to 200 nm, more preferably from 2 nm to 50 nm, and even more preferably from 2 nm to 20 nm.

<Electric Conductor>

The electric conductor of the present invention has the organic electroconductive polymer film on or above a support. Furthermore, an adhesive layer may also be formed for the purpose of enhancing the adhesiveness between the support and the organic electroconductive polymer film.

(1) Support

Any material which is in the form of a stable panel and which satisfies required flexibility, strength, durability may be used as the support capable of being used in the present invention. In the case where the resulting electroconductive polymer material is used in an image display device, a solar cell or the like, a high transparency is required and therefore the use of a transparent substrate with a smooth surface is preferred as a support.

In the present invention, examples of the material of the support may include a glass, a transparent ceramics, a metal and a plastic film. Glass and transparent ceramics are inferior in plasticity to a metal and a plastic film. Plastic film is less expensive than a metal and has plasticity.

Therefore, as the support of the present invention, a plastic film is preferable. The film is made of, for example, polyesters such as cellulose biacetate, cellulose triacetate, cellulose propionate, cellulose lactate, cellulose acetate lactate, cellulose nitrate, or polyethylene terephthalate; polyolefins such as polyethylene or polypropylene; or resins such as polystyrene, polycarbonate, polyvinylacetal, polyallylate, or cyclooefin polymer.

In particular, as a material for the support, a polyester-based resin (hereinafter, referred to as “polyester” appropriately) is preferable. As the polyester, a linear saturated polyester that is synthesized from an aromatic dibasic acid or an ester formable derivative thereof and a diol or an ester formable derivative thereof is preferable.

Specific examples of the polyester used for the support may include polyethylene terephthalate (PET), polyethylene isophthalate, polyethylene naphthalate (PEN), polybutylene terephthalate (PBT), poly(1,4-cyclohexylene dimethylene terephthalate),and polyethylene-2,6-phthalene dicarboxylate. Among these, from the viewpoint of availability, cost and effect, polyethylene terephthalate or polyethylene naphthalate is preferable, and polyethylene terephthalate is more preferable.

Moreover, a mixture of these copolymers or a mixture of these polymers with other resins in a small proportion may also be used as the material of a film, unless the effect of the present invention is impaired.

Furthermore, for the purpose of improving a smoothness, it is permissible to cause the polyester film to contain a small amount of inorganic or organic particles, for example, inorganic fillers, such as titanium oxide, calcium carbonate, silica and barium sulfate; organic fillers, such as acryls, silicone, benzoguanamine, Teflon (registered trademark) and epoxy resin. Adhesive improvers or antistatic agents, such as polyethylene glycol (PEG) and sodium dodecylbenzene sulfonate may be included into the polyester film.

The polyester film used in the present invention may be formed by melt extruding a polyester resin such as those mentioned above, into a film form, and subjecting the film to oriented crystallization by horizontal and vertical biaxial stretching, and to crystallization by heat treatment. The stretching ratio is not particularly limited, and preferably from 1.5 to 7 times, and more preferably about from 2 to 5 times. Particularly, a biaxially stretched product which has been stretched about 2 to 5 times respectively in the horizontal and vertical directions, is preferable. When the stretching ratio is within the range mentioned above, sufficient mechanical strength and uniform thickness may be obtained.

In regard to the method and conditions for the production of these films, known methods and conditions may be appropriately selected and used.

The thickness of the support is preferably from 30 μm to 500 μm, and more preferably from 100 μm to 300 μm, from the viewpoint of the handlability of the support or the size reduction or weight reduction of display devices, and further from the viewpoint of cost.

It is preferable to subject the support to a corona discharge treatment, an ozone treatment or the like, in order to increase the adhesiveness to the adhesive layer that will be described later.

(Adhesive Layer)

The adhesive layer contains a binder, and preferably further contains with a crosslinking agent. The adhesive layer may also contain fine particles and a surfactant as necessary.

—Binder—

For the binder of the adhesive layer, a polymer such as a polyester resin, an acrylic resin, a polyurethane resin or a rubber-based resin may be preferably used.

Polyester is the generic name of polymers that have an ester bonding in the main chain thereof, and is usually obtained through the reaction between a polycarboxylic acid and a polyol. Examples of the polycarboxylic acid may include fumaric acid, itaconic acid, adipic acid, sebacic acid, terephthalic acid, and isophthalic acid. Examples of the polyol may include ethylene glycol, 1,3-propane diol, 1,6-hexane diol, 1,5-pentane diol, 1,12-dodecane diol, and 1,4-cyclohexane dimethanol.

Polyester resin and the source chemicals thereof are described in “Polyester Jushi Handbook (Polyester Resin Handbook)” (edited by Eiichiro Takiyama, published by THE NIKKAN KOGYO SHINBUN, LTD., 1988).

The acrylic resin is a polymer that is composed of acrylic acid, methacrylic acid, or the derivatives thereof. A specific examples thereof may be included a polymer that is obtained by copolymerizing a main component including acrylic acid, methacrylic acid, methylmethacrylate, ethylacrylate, butylacrylate, 2-ethylhexylacrylate, acrylamide, acrylonitrile and hydroxylacrylate or the like with a monomer copolymerizable with the main component (styrene, divinylbenzene or the like, for example).

The polyurethane resin is the generic name of polymers that have an urethane bonding in the main chain thereof, and is usually obtained through the reaction between polyisocyanate and polyol. Examples of the polyisocyanate may include TDI, MDI, NDI, TODI, HDI, and IPDI. Examples of the polyol may include ethylene glycol, propylene glycol, glycerin, and hexane triol. Further, as the isocyanate of the present invention, a polymer that is obtained through the reaction between polyisocyanate and polyol and has a molecular weight increased by chain-extending treatment is also usable. The above described polyisocyanate, polyol, and chain-extending treatment are described in “Polyurethane Jushi Handbook (Polyurethane Resin Handbook)” (edited by Keiji Iwata, published by THE NIKKAN KOGYO SHINBUN, LTD., 1987), for example.

The rubber-based resin is referred to a diene-based synthetic rubber among synthetic rubbers. Examples thereof may include polybutadiene, styrene-butadiene copolymer, styrene-butadiene-acrylonitrile copolymer, styrene-butadiene-divinylbenzene copolymer, butadiene-acrylonitrile copolymer, and polychloroprene.

The rubber-based resins are described in “Gosei Gomu Handbook (Synthetic Rubber Handbook)” (edited by Shu Kambara et al., published by Asakura Publishing Co., Ltd., 1967), for example.

In regard to the binder, a solution of the binder dissolved in an organic solvent may be used, or an aqueous dispersion of the binder may be used. Considering low environmental burden, an aqueous dispersion is preferably coated in an aqueous system. A commercially available polymer may be used as an aqueous dispersion.

Examples of a polyester aqueous dispersion may include “FINETEX ES650 and ES2200” (trade names: polyester, manufactured by Dainippon Ink & Chemicals, Inc.); “VYLONAL MD1400 and MD1480” (trade names: polyester, manufactured by Toyobo Co., Ltd.); and “PLAS COAT Z 687” (trade name: polyester, manufactured by GOO CHEMICAL Co., LTD).

Examples of an acrylic resin aqueous dispersion may include “JURYMER ET325, ET410, and SEK301” (trade names: acryl, manufactured by Nihon Junyaku Co., Ltd.); “VONCOAT AN117 and AN226” (trade names: acryl, manufactured by Dainippon Ink & Chemicals, Inc.); and “EM48D” (trade name: acryl, manufactured by Daicel Chemical Industries, Ltd.).

Examples of a polyurethane resin aqueous dispersion may include “SUPER FLEX 830, 460, 870, 420, and 420NS” (trade names: polyurethane, manufactured by Dai-Ichi Kyogyo Seiyaku Co., Ltd.); “BONDIC 1370NS and 1320NS” (trade names: polyurethane, manufactured by Dainippon Ink & Chemicals, Inc.); and “OLESTER UD-350 and UD-800N”.

Examples of a rubber-based resin aqueous dispersion may include “LACSTAR DS616 and DS807” (trade names: styrene-butadiene rubber, manufactured by Dainippon Ink & Chemicals, Inc.); “NIPOL LX110, LX206, LX426, and LX433” (trade names: styrene-butadiene rubber, manufactured by ZEON Corp.); and “NIPOL LX513, LX1551, LX550, LX1571” (trade names: acrylonitrile-butadiene rubber, manufactured by ZEON Corp.).

The particle diameter of the dispersed particles of latex is preferably 5 μm or less, more preferably 1 μm or less, and even more preferably 0.2 μm or less. When the particle diameter is within the range mentioned above, aggregation of the particles is suppressed during the coating process, and the transparency, glossiness and the like of the film become excellent.

The polymers used as the binder may be used singly, or may also be used as mixtures of two or more species as necessary.

The molecular weight of the polymer used as the binder is not particularly limited, and from the viewpoints of the strength of the layer and the state of the coated surface, it is preferable to use a polymer having a weight average molecular weight of about from 3,000 to 1,000,000.

—Crosslinking Agent—

The adhesive layer may preferably contain a crosslinking agent, from the viewpoint of enhancing film strength.

Examples of the crosslinking agent used in the adhesive layer may include a carbodiimide compound, an oxazoline compound, and an epoxy compound. Considering film strength, a carbodiimide compound or an oxazoline compound is preferable. Among carbodiimide compounds, a compound having plural carbodiimide structures in the molecule thereof (hereinafter, referred to as “polycarbodiimide” in some cases) is still more preferable.

Polycarbodiimide is generally synthesized through condensation of an organic diisocyanate. The organic groups of the organic diisocyanate used for this synthesis is not particularly limited, and any of aromatic and aliphatic ones or a mixture thereof is usable. From the viewpoint of reactivity, aliphatic ones are particularly preferable. As the sources for the synthesis, an organic isocyanate, an organic diisocyanate, an organic triisocyanate or the like may be used.

Examples of the organic isocyanate may include an aromatic isocyanate, an aliphatic isocyanate, and a mixture thereof.

Specific examples thereof may include 4,4′-diphenylmethane diisocyanate, 4,4-diphenyldimethylmethane diisocyanate, 1,4-phenylene diisocyanate, 2,4-tolylene diisocyanate, 2,6-tolylene diisocyanate, hexamethylene diisocyanate, cyclohexane diisocyanate, xylylene diisocyanate, 2,2,4-trimethylhexamethylene diisocyanate, 4,4′-dicyclohexylmethane diisocyanate, and 1,3-phenylene diisocyanate. Examples of an organic monoisocyanate may include isophorone isocyanate, phenyl isocyanate, cyclohexyl isocyanate, butyl isocyanate, and naphthyl isocyanate.

The carbodiimide compound usable in the present invention may be available as a commercial product such as “CARBODILITE V-02-L2” (trade name: manufactured by Nisshinbo Chemical Inc.).

The carbodiimide compound of the present invention is preferably added in the range of from 15% to 100% by mass with respect to the binder and more preferably from 20% to 75% by mass. When the carbodiimide compound is added in the amount range mentioned above, the adhesiveness to a transparent film may be enhanced. Furthermore, in case where the adhesive layer contains fine particles, detachment of the fine particles may be prevented. Also from the viewpoint of lowering the production cost, it is desirable to limit the amount to the range mentioned above.

The oxazoline compound used in the present invention is a compound having an oxazoline group, and examples of the monomer having an oxazoline group may include 2-vinyl-2-oxazoline, 2-vinyl-4-methyl-2-oxazoline, 2-vinyl-5-methyl-2-oxazoline, 2-isopropenyl-2-oxazoline, 2-isopropenyl-4-methyl-2-oxazoline, 2-isopropenyl-5-methyl-2-oxazoline and the like. These may be used singly, or as mixtures of two or more species. The oxazoline compounds used in the present invention are also available as commercially available products such as, for example, EPOCROS K2020E (trade name, manufactured by Nippon Shokubai Co., Ltd.).

In the present invention, the oxazoline compound is preferably added in an amount in the range of from 10 to 65% by mass, and more preferably in the range of 12 to 63% by mass, with respect to the binder.

When the oxazoline compound is added in the range mentioned above, imparting water resistance is satisfactorily achieved, and high adhesiveness is maintained even under severe conditions such as exposure to high temperature and hot water treatment, without losing the adhesiveness to transparent films. Furthermore, the occurrence of liquid aggregation is suppressed.

—Other Additives—

The adhesive layer may also include various additives such as fine particles or a surfactant in addition to those described above, in accordance with the use.

As for the fine particles that may be used in the adhesive layer of the present invention, both organic and inorganic fine particles may be used. For the fine particles, those explained in regard to the dielectric layer may be applied.

The surfactant that may be used in the adhesive layer may include those surfactants explained in the dielectric layer may be mentioned.

—Property Values and the Like—

The thickness of the adhesive layer is preferably set to from 10 nm to 500 nm, in order to obtain adhesiveness to transparent films. More preferably, the thickness of the adhesive layer is set to from 30 nm to 150 nm. When the thickness of the adhesive layer is within the range mentioned above, the adhesiveness to the support is sufficiently exhibited, and deterioration of the surface state is suppressed.

The amount of coating of the adhesive layer is preferably in the range of from 100 mg/m² to 250 mg/m², and more preferably in the range of from 120 mg/m² to 230 mg/m². When the amount of coating of the adhesive layer is set to the range mentioned above, the adhesiveness to transparent films may be maintained constant, without having the occurrence of coating irregularities or the like.

—Producing Method—

The method of forming an adhesive layer is not particularly limited, and it is preferable to provide the adhesive layer by coating. As for the method of coating, known methods such as bar coater coating and slide coater coating may be used.

Upon forming the adhesive layer by coating, a solvent (coating solvent) may be used. As for the coating solvent, aqueous and organic solvent-based coating solvents, such as water, toluene, methyl alcohol, isopropyl alcohol, methyl ethyl ketone, and mixtures thereof, may be used. Among these, a method of using water as the coating solvent is preferable in consideration of the cost and the convenience in production.

<Resistive Film Touch Panel>

The resistive film touch panel of the present invention includes a first electric conductor having an electroconductive film on a transparent film that is a support, and a second electric conductor having an electroconductive film on a substrate that is a support, and the the electroconductive film of the first electric conductor and the electroconductive film of the second electric conductor are opposed to each other. At least one of the electroconductive films of the first electric conductor or the second electric conductor is the organic electroconductive polymer film described above. In a preferable case, the electroconductive film of the first electric conductor is the organic electroconductive polymer film of the present invention.

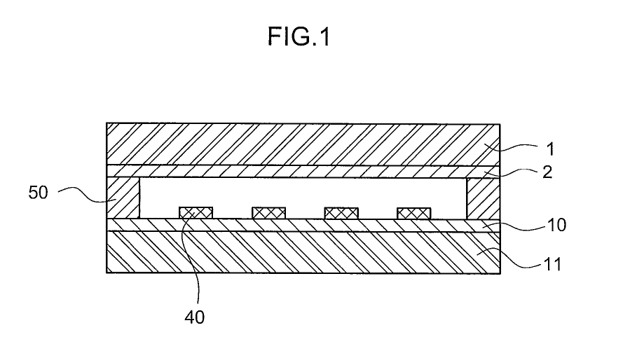

FIG. 1 is a schematic cross-sectional view that explains an exemplary resistive film touch panel of the present invention.

In the resistive film touch panel, the first electric conductor which serves as a touch surface where inputting is performed with a fingertip or the like, and the second electric conductor are disposed to face each other, with an insulating spacer 50 interposed therebetween. The first electric conductor has a transparent electroconductive film 2 on a transparent film 1. The second electric conductor has an electroconductive film 10 on a substrate 11. At least one of the transparent electroconductive film 2 or the electroconductive film 10 is the organic electroconductive polymer film described above. A dot spacer 40 is formed on the electroconductive film 10.

When the touch surface in the first electric conductor is pressed from the outside, the first electric conductor is deformed, and the transparent electroconductive film 2 at the pressed part is partially contacted with the electroconductive film 10. As a result, electricity flows, and a signal (electrical potential) can be outputted, so that an input device is operated and driven.

(Support)

As for the support in the resistive film touch panel, the support explained previously in regard to the electric conductor may be used. Here, among the supports mentioned above, the support in the first electric conductor is a transparent film. Other than that, the supports mentioned above may be applied, and the same also applies to the preferable range.

The transparent film of the first electric conductor may include a plastic film. Examples of the he transparent film may include films using polyesters such as cellulose diacetate, cellulose triacetate, cellulose propionate, cellulose butyrate, cellulose acetate butyrate, nitrocellulose, and polyethylene terephthalate; polyolefins such as polyethylene and polypropylene; resins such as polystyrene, polycarbonate, polyvinylacetal, polyallylate and cycloolefin polymers.

In particular; as for the transparent film, a polyester-based resin (hereinafter, appropriately referred to as “polyester”) is preferred. As for the polyester, a linear saturated polyester synthesized from an aromatic dibasic acid or a derivative thereof capable of forming an ester, and a diol or a derivative thereof capable of forming an ester, is preferable.

Specific examples of the polyester that may be used in the transparent film may include polyethylene terephthalate (PET), polyethylene isophthalate, polyethylene naphthalate (PEN), polybutylene terephthalate (PBT), poly(1,4-cyclohexylenedimethylene terephthalate), polyethylene-2,6-phthalene dicarboxylate, and the like. Among these, polyethylene terephthalate and polyethylene naphthalate are preferable from the viewpoints of easy availability, economic efficiency and effects, and polyethylene terephthalate is more preferable.

(Adhesive Layer)

In the resistive film touch panel, an adhesive layer may be formed for the purpose of enhancing the adhesiveness between the support and the organic electroconductive polymer film. In regard to this adhesive layer, the adhesive layer explained previously in regard to the electric conductor may be applied, and the same also applies to the preferable range.

(Property Values and the Like)

The resistive film touch panel of the present invention is excellent in the linearity of the internal resistance value with respect to the positional variant, because the organic electroconductive polymer film of the present invention in which the in-plane fluctuation of surface resistance is suppressed, is used. The linearity is determined by the following method.

A straight line having a length of 20 mm is recorded (drawn) in a reciprocating manner on a transparent electroconductive base material, using a polyacetal pen having a pen tip of 0.8R under a pen load of 300 g, at a rate of 210 mm/min. The linearity, which measures the linearity of the resistance value at every 1000 times when a single reciprocation is taken as one time of drawing, is calculated by the following expression.

Linearity=(ΔE/E)×100%

Here, E is the calculated voltage at an arbitrary point Xₓ between point X1 and point X2, when the two ends of the straight line drawn by a measuring terminal P are designated as X1 and X2, respectively, E being calculated based on a straight line connecting the voltage EX₁ obtained when the measuring terminal P is on the point X1, and the voltage EX₂ obtained when the measuring terminal P is on the point X2. ΔEₓ is the difference between the calculated value of Eₓ and the actually measured value of EXₓ at the point Xₓ. Using the maximum value of ΔEₓ on the straight line connecting X1 and X2, the value of linearity is determined by the calculation expression shown above.

The resistive film touch panel of the present invention may have the linearity adjusted to from −3% to +3%, and may even have the linearity adjusted to from +1.5% to −1.5%. Such excellent linearity values are obtained by the present invention because the in-plane fluctuation of surface resistance is significantly suppressed.

<Usages>

The organic electroconductive polymer coating liquid of the present invention gives an organic electroconductive polymer film having the in-plane fluctuation of surface resistance suppressed, and an electric conductor. These electroconductive film and electric conductor may be preferably used as the wiring or electrodes (substrate electrode or the like) of electronic materials. In particular, since the formation of an electroconductive film by coating is possible, electrode materials having large surface area can be easily produced, and the application of the electroconductive polymer coating liquid to substrate electrodes is appropriate.

Such an electroconductive film may be preferably used in flexible electroluminescent devices (OLED), touch screens, touch panels, organic TFT's, actuators, sensors, electronic papers, flexible modulating materials, solar cells or the like. Particularly, since the in-plane fluctuation of surface resistance is small, the electroconductive film may be preferably used in the resistive film touch panels.

The resulting resistive film touch panels have an excellent linearity in the internal resistance value with respect to the positional variant.

### Examples

Hereinafter, the present invention will be described more specifically by way of Examples. The materials, reagents, amounts of material and proportions, operations and the like shown in the following Examples may be appropriately altered as long as the main gist of the present invention is not departed. Therefore, the scope of the present invention is not intended to be limited to the following Examples.

<Method for Measuring Surface Resistance>

A formed electroconductive polymer film was cut to a size of 80 mm×120 mm. The surface resistance was measured at 28 points of measurement site under the conditions of 25° C. and 50% RH, using a surface resistance meter (trade name: LORESTA GP Model MCP-T610, manufactured by Mitsubishi Chemical Corp.), by moving a measuring probe as an ASP at a pitch interval of 16 mm in the X direction and 15 mm in the Y direction.

The average value and the standard deviation were determined from the measured surface resistance values, and the value of the in-plane fluctuation of surface resistance (CV value) was calculated by the following expression.

CV value=(standard deviation)/(average value)×100

A CV value of from 0 to less than 3.0% was graded as excellent, a CV value of from 3.0% to less than 5.0% was graded as good, and a CV value of from 5.0% or more was graded as unusable.

<Evaluation of Electroconductive Polymer Film by Visual Inspection>

The electroconductive polymer film was evaluated by visual inspection. The case of having visible streak-like defects on the film surface was graded as a grade C, the case of having no visible defects was graded as a grade B, and the case of having high transparency was graded as a grade A.

<Evaluation of Durability Against Humidity and Heat>

The surface resistance value of a sample coated with the electroconductive polymer, which had been stored for 500 hours in an environment of 60° C. and 90% RH, was measured, and the initial value and the value obtained after the storage were compared.

<Production of PET Film Provided with Adhesive Layer>

### (Production of Support)

A polyethylene terephthalate (hereinafter, indicated as PET) resin produced by polycondensation using Ge as a catalyst, was dried to have a water content of 50 ppm or less, and was melted in an extruder, with the heater temperature set at 280 to 300° C. The molten PET resin was ejected from the die section onto an electrostatically charged chill roll, and thus an amorphous base was obtained. The obtained amorphous base was stretched to 3.3 times in the direction of movement of the base, and then was stretched to 3.8 times in the width direction, to thus obtain a support having a thickness of 188 μm.

(Formation of Adhesive Layer)

The support formed as described above was subjected to a corona discharge treatment on both sides under the condition of 730 J/m², and then the two surfaces were coated with a coating liquid A for adhesive layer that will be described below, in an amount of coating of 4.4 cm³/m² by a bar coating method. This was then dried for one minute at 160° C. to form adhesive layers, and thereby a laminate sheet having adhesive layers applied on both sides of a support (electric conductor) was obtained.

—Composition of Coating Liquid A for Adhesive Layer—

| | |
|---|---|
| Urethane resin binder | 30.7 parts by mass |
| (trade name: OLESTER UD350, manufactured by | |
| Mitsui Chemicals, Inc., solids content 38% by | |
| mass, glass transition temperature 33° C.) | |
| Acrylic resin binder | 4.2 parts by mass |
| (trade name: AS563, manufactured by Daicel | |
| Finechem, Ltd., solids content 27.5% | |
| by mass, glass transition temperature 47° C.) | |
| Crosslinking agent (trade name: | 5.8 parts by mass |
| CARBODILITE V-02-L2, manufactured | |
| by Nisshinbo Holdings, Inc., solids content | |
| 40% by mass) | |
| Additive (filler) | 1.9 parts by mass |
| (trade name: AEROSIL OX-50, manufactured | |
| by Nippon Aerosil Co., Ltd., solids | |
| content 10% by mass) | |
| Additive (filler) | 0.8 parts by mass |
| (trade name: SNOWTEX XL, manufactured by | |
| Nissan Chemical Industries, Ltd., solids content | |
| 40% by mass) | |
| Additive (sliding agent) | 1.9 parts by mass |
| (trade name: CELLOSOL 524, manufactured by | |
| Chukyo Yushi Co., Ltd., solids content 30% | |
| by mass) | |
| Surfactant 1 | 15.5 parts by mass |
| (trade name: RAPISOL B-90, manufactured by | |
| NOF Corp., anionic, 1% by mass) | |
| Surfactant 2 | 19.4 parts by mass |
| (trade name: NAROACTY CL-95, manufactured | |
| by Sanyo Chemical Industries, Ltd., nonionic, | |
| 1% by mass) | |
| Pure water | added to obtain 1000 |
| | parts by mass in total |

### Example 1

To 40 parts by mass of an aqueous dispersion of PEDOT/PSS (trade name: CLEVIOS PH500, manufactured by H.C. Starck, Ltd., average dispersed particle diameter 30 nm, solid concentration 1.2% by mass), 54 parts by mass of methanol and 6 parts by mass of ethylene glycol were added, and the mixture was stirred for 30 minutes with a mix rotor (trade name: MR-3, manufactured by As One Corp.), and then was filtered through a membrane filter having a pore size of 10 μm. Thereby, an organic electroconductive polymer coating liquid 1 containing an electroconductive polymer and a dopant was produced.

The viscosity of the coating liquid 1 was 5.8 mPa·s, and the solid concentration was 0.48% by mass.

The organic electroconductive polymer coating liquid 1 was applied on the PET film having adhesive layers laminated thereon, using a wire bar (#9), and the film was dried on a hot plate at a surface temperature of 100° C. for 10 minutes, to thus produce an electroconductive polymer film.

Subsequently, a coating liquid was prepared by mixing 0.2 parts by mass each of 1-hydroxyethane-1,1-diphosphonic acid and N-methyl-2-dimethylamino acetohydroxamic acid, 9 parts by mass of isopropyl alcohol, and 1 part by mass of ethylene glycol.

This coating liquid was applied on the electroconductive polymer film 1 with a wire bar (#3), and the film was dried on a hot plate at a surface temperature of 100° C. for 10 minutes, and then was annealed in an oven at an in-chamber temperature of 120° C. Thereby, an electroconductive polymer film 1 having a laminate structure was obtained.

The surface resistance of the electroconductive polymer film 1 was 520 Ω/sq. The CV value was 2.10% to be judged as excellent.

In regard to the durability against humidity and heat, the ratio of change in surface resistance was 118%.

### Example 2

An organic electroconductive polymer coating liquid 2 was produced in the same manner as in the case of the organic electroconductive polymer coating liquid 1 of Example 1, except that 42 parts by mass of methanol, 21 parts by mass of pure water and 6 parts by mass of ethylene glycol were added to 30 parts by mass of an aqueous dispersion of PEDOT/PSS, CLEVIOS PH500 (trade name, manufactured by H.C. Starck, Ltd., average dispersed particle diameter 30 nm, solid concentration 1.2% by mass).

The viscosity of the coating liquid 2 was 5.2 mPa·s, and the solid concentration was 0.36% by mass.

The organic electroconductive polymer coating liquid 2 was applied on the PET film with a wire bar (#9), and the film was dried on a hot plate at a surface temperature of 100° C. for 10 minutes, to thus produce an electroconductive polymer film 2.

The surface resistance of the electroconductive polymer film 2 was 589 Ω/sq. The CV value was 3.82% to be judged as good.

In regard to the durability against humidity and heat, the ratio of change in surface resistance was 117%.

### Example 3

An organic electroconductive polymer coating liquid 3 was produced in the same manner as in the case of the organic electroconductive polymer coating liquid 1 of Example 1, except that 56 parts by mass of methanol, 21 parts by mass of methyl ethyl ketone and 6 parts by mass of ethylene glycol were added to 30 parts by mass of an aqueous dispersion of PEDOT/PSS, CLEVIOS PH500 (trade name, manufactured by H.C. Starck, Ltd., average dispersed particle diameter 30 nm, solid concentration 1.2% by mass).

The viscosity of the coating liquid 3 was 4.1 mPa·s, and the solid concentration was 0.36% by mass.

The organic electroconductive polymer coating liquid 3 was applied on the PET film with a wire bar (#9), and the film was dried on a hot plate at a surface temperature of 100° C. for 10 minutes, to thus produce an electroconductive polymer film 3.

The surface resistance of the electroconductive polymer film 3 was 659 Ω/sq. The CV value was 3.49% to be judged as good.

In regard to the durability against humidity and heat, the ratio of change in surface resistance was 118%.

### Example 4

An organic electroconductive polymer coating liquid 4 was produced in the same manner as in the case of the organic electroconductive polymer coating liquid 1 of Example 1, except that 58.5 parts by mass of methanol and 1.5 parts by mass of diethylene glycol were added to 40 parts by mass of an aqueous dispersion of PEDOT/PSS, CLEVIOS PH500 (trade name, manufactured by H.C. Starck, Ltd., average dispersed particle diameter 30 nm, solid concentration 1.2% by mass).

The viscosity of the coating liquid 4 was 5.3 mPa·s, and the solid concentration was 0.48% by mass.

The organic electroconductive polymer coating liquid 4 was applied on the PET film with a wire bar (#9), and the film was dried on a hot plate at a surface temperature of 100° C. for 10 minutes, to thus produce an electroconductive polymer film 4.

Subsequently, a coating liquid was prepared by mixing 0.2 parts by mass each of 1-hydroxyethane-1,1-diphosphonic acid and N-methyl-2-dimethylaminoacetohydroxamic acid, 9 parts by mass of isopropyl alcohol, and 1 part by mass of ethylene glycol.

This coating liquid was applied on the electroconductive polymer film 4 with a wire bar (#3), and the film was dried on a hot plate at a surface temperature of 100° C. for 10 minutes, and then was annealed in an oven at an in-chamber temperature of 120° C. Thereby, an electroconductive polymer film 4 having a laminate structure was obtained.

The surface resistance of the electroconductive polymer film 4 was 458 Ω/sq. The CV value was 3.18% to be judged as good.

In regard to the durability against humidity and heat, the ratio of change in surface resistance was 114%.

### Example 5

An organic electroconductive polymer coating liquid 5 was produced in the same manner as in the case of the organic electroconductive polymer coating liquid 1 of Example 1, except that 67.5 parts by mass of ethanol and 7.5 parts by mass of ethylene glycol were added to 25 parts by mass of an aqueous dispersion of PEDOT/PSS, CLEVIOS PH500 (trade name, manufactured by H.C. Starck, Ltd., average dispersed particle diameter 30 nm, solid concentration 1.2% by mass).

The viscosity of the coating liquid 5 was 4.4 mPa·s, and the solid concentration was 0.30% by mass.

The organic electroconductive polymer coating liquid 5 was applied on the PET film with a wire bar (#18), and the film was dried on a hot plate at a surface temperature of 100° C. for 10 minutes, to thus produce an electroconductive polymer film 5.

Subsequently, a coating liquid was prepared by mixing 0.2 parts by mass each of 1-hydroxyethane-1,1-diphosphonic acid and N-methyl-2-dimethylamino acetohydroxamic acid, 9 parts by mass of isopropyl alcohol, and 1 part by mass of ethylene glycol.

This coating liquid was applied on the electroconductive polymer film 5 with a wire bar (#3), and the film was dried on a hot plate at a surface temperature of 100° C. for 10 minutes, and then was annealed in an oven at an in-chamber temperature of 120° C. Thereby, an electroconductive polymer film 5 having a laminate structure was obtained.

The surface resistance of the electroconductive polymer film 5 was 496 Ω/sq. The CV value was 2.71% to be judged as excellent.

In regard to the durability against humidity and heat, the ratio of change in surface resistance was 116%.

### Example 6

A dielectric layer coating liquid 6 containing 0.5 parts by mass of PVA217 (trade name, manufactured by Kuraray Co., Ltd.), 71.6 parts by mass of pure water and 28.9 parts by mass of methanol, was applied on the electroconductive polymer film 1 having a laminate structure produced in Example 1, using a wire bar (#3). The film was dried on a hot plate at a surface temperature of 100° C. for 10 minutes. Thus, an electroconductive polymer film 6 having a dielectric layer laminated thereon was produced.

The surface resistance of the electroconductive polymer film 6 was 545 Ω/sq.

The CV value of the electroconductive polymer film 6 was determined, and was found to be 2.73% to be judged as excellent.

In regard to the durability against humidity and heat, the ratio of change in surface resistance was 113%, exhibiting excellent durability.

### Example 7

### —Composition of Dielectric Layer Coating Liquid 7—

| | |
|---|---|
| Polyolefin ionomer | 23 parts by mass |
| (trade name: CHEMIPAL S-120, manufactured | |
| by Mitsui Chemicals, Inc., solids content 27% | |
| by mass) | |
| Epoxy compound (trade name: | 220 parts by mass |
| DENACOL EX-614B, manufactured by | |
| Nagase ChemteX Corp.) | |
| Additive (filler) | 15 parts by mass |
| (trade name: SNOWTEX CL, manufactured by | |
| Nissan Chemical Industries, Ltd., solids content | |
| 20 parts by mass) | |
| Thickening agent | 11 parts by mass |
| (polystyrene sulfonate, solids content 3 by mass) | |
| Surfactant 1 | 8 parts by mass |
| (trade name: SANDET BL, manufactured by | |
| Sanyo Chemical Industries, Ltd., solids content | |
| 10% by mass) | |
| Surfactant 2 | 19 parts by mass |
| (polyoxyethylene octyl phenyl ether-glycidol | |
| adduct, solid concentration 4% by mass) | |
| Pure water | added to obtain 1000 |
| | parts by mass in total |

A dielectric layer coating liquid 7 having the composition shown above was applied on the electroconductive polymer film 1 having a laminate structure produced in Example 1, using a wire bar (#3), and the film was dried on a hot plate at a surface temperature of 100° C. for 10 minutes, and then was annealed in an oven at an in-chamber temperature of 80° C. Thereby, an electroconductive polymer film 7 having a dielectric layer laminated thereon was obtained.

The surface resistance of the electroconductive polymer film 7 was 510 Ω/sq.

The CV value of the electroconductive polymer film 7 was determined, and was found to be 4.21% to be judged as good.

In regard to the durability against humidity and heat, the ratio of change in surface resistance was 107%, exhibiting excellent durability.

### Example 8

To 40 parts by mass of an aqueous dispersion of PEDOT/PSS (trade name: CLEVIOS PH500, manufactured by H.C. Starck, Ltd., average dispersed particle diameter 30 nm, solid concentration 1.2% by mass), 54 parts by mass of methanol, 6 parts by mass of ethylene glycol, and 0.025 parts by mass of a nonionic surfactant, (trade name: Polyethylene Glycol Mono-4-octylphenyl Ether n(=:) 10, manufactured by Tokyo Chemical Industry Co., Ltd.) were added, and the mixture was stirred for 30 minutes with a mix rotor (trade name: MR-3, manufactured by As One Corp.), and then was filtered through a membrane filter having a pore size of 10 μm Thereby, an organic electroconductive polymer coating liquid 8 containing an electroconductive polymer and a dopant was produced. The viscosity of the coating liquid 8 was 5.9 mPa·s, and the solid concentration was 0.51% by mass.

The organic electroconductive polymer coating liquid 8 was applied on a PET film having adhesive layers laminated thereon in the same manner as in Example 1, using a wire bar (#9), and the film was dried on a hot plate at a surface temperature of 100° C. for 10 minutes. Thus, an electroconductive polymer film 8 was produced.

Subsequently, a coating liquid was prepared by mixing 0.1 parts by mass each of 1-hydroxyethane-1,1-diphosphonic acid and N-methyl-2-dimethylamino acetohydroxamic acid, 9 parts by mass of isopropyl alcohol, and 1 part by mass of ethylene glycol.

This coating liquid was applied on the electroconductive polymer film 8 with a wire bar (#3), and the film was dried on a hot plate at a surface temperature of 100° C. for 10 minutes, and then was annealed in an oven at an in-chamber temperature of 120° C. Thereby, an electroconductive polymer film 8 having a laminate structure was obtained.

The surface resistance of the electroconductive polymer film 8 was 510 Ω/sq. The CV value was 3.2% to be judged as good.

In regard to the durability against humidity and heat, the ratio of change in surface resistance was 125%.

### Example 9

An electroconductive polymer film 9 was produced in the same manner as in Example 8, except that the nonionic surfactant was changed from Polyethylene Glycol Mono-4-octylphenyl Ether n(=:) 10 to FS-300 (trade name, manufactured by DuPont Company). The viscosity of the used coating liquid 9 was 5.8 mPa·s, and the solid concentration was 0.51% by mass.

The surface resistance of the electroconductive polymer film 9 was 505 Ω/sq. The CV value was 2.9% to be judged as excellent.

In regard to the durability against humidity and heat, the ratio of change in surface resistance was 122%.

### Example 10

An electroconductive polymer film 10 was produced in the same manner as in Example 8, except that the nonionic surfactant was changed from Polyethylene Glycol Mono-4-octylphenyl Ether n(=:) 10 to FSO-100 (trade name, manufactured by DuPont Company). The viscosity of the used coating liquid 10 was 6.0 mPa·s, and the solid concentration was 0.51% by mass.

Subsequently, a dielectric layer coating liquid containing 0.5 parts by mass of PVA217 (trade name, manufactured by Kuraray Co., Ltd.), 71.6 parts by mass of pure water, and 28.9 parts by mass of methanol, was applied on the electroconductive polymer film 10 having a laminate structure, using a wire bar (#3). The film was dried on a hot plate at a surface temperature of 100° C. for 10 minutes, and thus an electroconductive polymer film 10 having a dielectric layer laminated thereon was produced.

The surface resistance of the electroconductive polymer film 10 was 499 Ω/sq. The CV value was 2.9% to be judged as excellent.

In regard to the durability against humidity and heat, the ratio of change in surface resistance was 114%.

### Comparative Example 1

An organic electroconductive polymer coating liquid 1 for comparison was produced in the same manner as in the case of the organic electroconductive polymer coating liquid 1 of Example 1, except that 54 parts by mass of methanol and 6 parts by mass of ethylene glycol were added to 40 parts by mass of an aqueous dispersion of PEDOT/PSS (trade name: CLEVIOS P HC V4, manufactured by H.C. Starck, Ltd., average dispersed particle diameter 200 nm, solid concentration 1.2% by mass).

The viscosity of the coating liquid 1 for comparison was 5.1 mPa·s, and the solid concentration was 0.48% by mass.

The organic electroconductive polymer coating liquid 1 for comparison was applied on the PET film with a wire bar (#9), and the film was dried on a hot plate at a surface temperature of 100° C. for 10 minutes. Thus, an electroconductive polymer film 1 for comparison was produced.

The surface resistance of the electroconductive polymer film 1 for comparison was 560 Ω/sq. The CV value was 5.58% to be judged as unusable.

In regard to the durability against humidity and heat, the ratio of change in surface resistance was 130%.

### Comparative Example 2

An organic electroconductive polymer coating liquid 2 for comparison was produced in the same manner as in the case of the organic electroconductive polymer coating liquid 1 of Example 1, except that 36 parts by mass of ethanol, 18 parts by mass of pure water, and 6 parts by mass of ethylene glycol were added to 40 parts by mass of an aqueous dispersion of PEDOT/PSS (trade name: CLEVIOS PH500, manufactured by H.C. Starck, Ltd., average dispersed particle diameter 30 nm, solid concentration 1.2% by mass).

The viscosity of the coating liquid 2 for comparison was 8.8 mPa·s, and the solid concentration was 0.48% by mass.

The organic electroconductive polymer coating liquid 2 for comparison was applied on the PET film with a wire bar (#9), and the film was dried on a hot plate at a surface temperature of 100° C. for 10 minutes. Thus, an electroconductive polymer film 2 for comparison was produced.

The surface resistance of the electroconductive polymer film 2 for comparison was 414 Ω/sq. The CV value was 7.32% to be judged as unusable.

In regard to the durability against humidity and heat, the ratio of change in surface resistance was 122%.

### Comparative Example 3

An organic electroconductive polymer coating liquid 3 for comparison was produced in the same manner as in the case of the organic electroconductive polymer coating liquid 1 of Example 1, except that 36 parts by mass of isopropyl alcohol, 18 parts by mass of pure water, and 6 parts by mass of ethylene glycol were added to 40 parts by mass of an aqueous dispersion of PEDOT/PSS (trade name: CLEVIOS PH500, manufactured by H.C. Starck, Ltd., average dispersed particle diameter 30 nm, solid concentration 1.2% by mass).

The viscosity of the coating liquid 3 for comparison was 10 mPa·s, and the solid concentration was 0.48% by mass.

The organic electroconductive polymer coating liquid 3 for comparison was applied on the PET film with a wire bar (#9), and the film was dried on a hot plate at a surface temperature of 100° C. for 10 minutes. Thus, an electroconductive polymer film 3 for comparison was produced.

The surface resistance of the electroconductive polymer film 3 for comparison was 456 Ω/sq. The CV value was 6.23% to be judged as unusable.

In regard to the durability against humidity and heat, the ratio of change in surface resistance was 120%.

### Comparative Example 4

An organic electroconductive polymer coating liquid 4 for comparison was produced in the same manner as in the case of the organic electroconductive polymer coating liquid 1 of Example 1, except that 35 parts by mass of methanol, 28 parts by mass of pure water, and 6 parts by mass of ethylene glycol were added to 30 parts by mass of an aqueous dispersion of PEDOT/PSS (trade name: CLEVIOS PH500, manufactured by H.C. Starck, Ltd., average dispersed particle diameter 30 nm, solid concentration 1.2% by mass).

The viscosity of the coating liquid 4 for comparison was 6.9 mPa·s, and the solid concentration was 0.36% by mass.

The organic electroconductive polymer coating liquid 4 for comparison was applied on the PET film with a wire bar (#9), and the film was dried on a hot plate at a surface temperature of 100° C. for 10 minutes. Thus, an electroconductive polymer film 4 for comparison was produced.

The surface resistance of the electroconductive polymer film 4 for comparison was 469 Ω/sq. The CV value was 5.55% to be judged as unusable.

In regard to the durability against humidity and heat, the ratio of change in surface resistance was 128%.

TABLE 1

| | | | | Dispersed | | | | Durability | | |
|---|---|---|---|---|---|---|---|---|---|---|
| | | | | particle | Solid | CV | | against | Evaluation | |
| | | Polyhydric | Viscosity | diameter | concentration | value | | humidity | by visual | |
| | Solvent | alcohol | (mPa · s) | (nm) | (mass %) | (%) | Judgement | and heat (%) | inspection | Remarks |
| Example 1 | Water, Methanol | Ethylene glycol | 5.8 | 30 | 0.48 | 2.10 | Excellent | 118 | B | |
| Example 2 | Water, Methanol | Ethylene glycol | 5.2 | 30 | 0.36 | 3.82 | Good | 117 | B | |
| Example 3 | Water, Methanol, | Ethylene glycol | 4.1 | 30 | 0.36 | 3.49 | Good | 118 | B | |
| | Methyl ethyl ketone | | | | | | | | | |
| Example 4 | Water, Methanol | Diethylene | 5.3 | 30 | 0.48 | 3.18 | Good | 114 | B | |
| | | glycol | | | | | | | | |
| Example 5 | Water, Methanol | Ethylene glycol | 4.4 | 30 | 0.30 | 2.71 | Excellent | 116 | B | |
| Example 6 | Water, Methanol | Ethylene glycol | 5.8 | 30 | 0.48 | 2.73 | Excellent | 113 | B | Dielectric |
| | | | | | | | | | | layer: |
| | | | | | | | | | | PVA |
| Example 7 | Water, Methanol | Ethylene glycol | 5.8 | 30 | 0.48 | 4.21 | Good | 107 | B | Dielectric |
| | | | | | | | | | | layer: |
| | | | | | | | | | | epoxy |
| Example 8 | Water, Methanol | Ethylene glycol | 5.9 | 30 | 0.51 | 3.20 | Good | 125 | B | |
| Example 9 | Water, Methanol | Ethylene glycol | 5.8 | 30 | 0.51 | 2.90 | Excellent | 122 | A | |
| Example 10 | Water, Methanol | Ethylene glycol | 6.0 | 30 | 0.51 | 2.90 | Excellent | 114 | A | Dielectric |
| | | | | | | | | | | layer: |
| | | | | | | | | | | PVA |
| Comparative | Water, Methanol | Ethylene glycol | 5.1 | 200 | 0.48 | 5.58 | Unusable | 130 | B | |
| Example 1 | | | | | | | | | | |
| Comparative | Water, Methanol | Ethylene glycol | 8.8 | 30 | 0.48 | 7.32 | Unusable | 122 | C | |
| Example 2 | | | | | | | | | | |
| Comparative | Water, | Ethylene glycol | 10 | 30 | 0.48 | 6.23 | Unusable | 120 | C | |
| Example 3 | Isopropyl alcohol | | | | | | | | | |
| Comparative | Water, Methanol | Ethylene glycol | 6.9 | 30 | 0.36 | 5.55 | Unusable | 128 | C | |
| Example 4 | | | | | | | | | | |

As shown in the Table 1, in Examples 1 to 10 in which the viscosity of the organic electroconductive polymer coating liquid was 6.0 mPa·s or less, and the average value of the dispersed particle diameter of the electroconductive polymer and the dopant was 50 nm or less, electroconductive films (electric conductors) having lower values of the in-plane fluctuation of surface resistance (CV values) were obtained.

In Examples 6, 7 and 10 in which a dielectric layer was further provided, the durability against humidity and heat was enhanced without significantly decreasing the CV values.

In Examples 9 and 10 in which fluorine-containing nonionic surfactants were added, electroconductive films (electric conductors) having excellent transparency judged based on visual inspection were obtained.

### Example 11

### (Production of Touch Panel Device)

A film having an adhesive layer and a poly(3,4-ethylenedioxy)thiophene (PEDOT)/polystyrene sulfonic acid (PSS) layer provided on a PET film, was produced by the same procedure as that used in Example 1.

Subsequently, a substrate was prepared by providing indium tin oxide on a glass substrate by deposition, a dot spacer (product name: RESIST CR-103C, manufactured by Toyobo Co., Ltd.) having a thickness of 4 μm was formed by photolithography, and then a wiring was formed with a silver paste (product name: DW-250H-5, manufactured by Toyobo Co., Ltd.) by screen printing. Furthermore, insulation sites were formed with an insulating ink (trade name: JELCON IN, manufactured by Jujo Chemical Co., Ltd.). Finally, the aforementioned film was bonded to the substrate to produce a touch panel device.

(Evaluation of Touch Panel Device)

The linearity of the touch panel device was measured and was found to be ±2.5% or less, and it was confirmed that the touch panel device had excellent linearity.

### Example 12

A touch panel was produced in the same manner as in Example 11, except that the electroconductive polymer film 10 produced in Example 10 was used instead.

The linearity of this touch panel was measured and was found to be ±1.2% or less, and it was confirmed that the touch panel had excellent linearity.

The foregoing description of the embodiments of the present invention has been provided for the purposes of illustration and description. It is not intended to be exhaustive or to limit the present invention to the precise forms disclosed. Obviously, many modifications and variations will be apparent to practitioners skilled in the art. The embodiments were chosen and described in order to best explain the principles of the present invention and its practical applications, thereby enabling others skilled in the art to understand the present invention for various embodiments and with the various modifications as are suited to the particular use contemplated. It is intended that the scope of the present invention be defined by the following claims and their equivalents.

All publications, patent applications, and technical standards mentioned in this specification are herein incorporated by reference to the same extent as if each individual publication, patent application, or technical standard was specifically and individually indicated to be incorporated by reference.

What is claimed is:

1. An organic electroconductive polymer coating liquid comprising an electroconductive polymer and a dopant, which are dispersed in at least one selected from a monohydric alcohol, a ketone or water, wherein the average value of a dispersed particle diameter of the electroconductive polymer and the dopant is 50 nm or less, and the viscosity of the coating liquid is 6.0 mPa·s or less.

2. The organic electroconductive polymer coating liquid according to claim 1, further comprising a polyhydric alcohol.

3. The organic electroconductive polymer coating liquid according to claim 1, wherein the electroconductive polymer includes a polythiophene.

4. The organic electroconductive polymer coating liquid according to claim 3, wherein the polythiophene includes poly(3,4-ethylenedioxy)thiophene.

5. The organic electroconductive polymer coating liquid according to claim 1, wherein the dopant is a water-soluble polymer.

6. The organic electroconductive polymer coating liquid according to claim 1, wherein the dopant includes at least one selected from polystyrene sulfonic acid or a copolymer of styrene sulfonic acid.

7. The organic electroconductive polymer coating liquid according to claim 1, wherein the total solid concentration of the electroconductive polymer and the dopant is from 0.2% by mass to 0.7% by mass.

8. The organic electroconductive polymer coating liquid according to claim 1, further comprising a nonionic surfactant.

9. The organic electroconductive polymer coating liquid according to claim 1, further comprising a fluorine-containing nonionic surfactant.

10. The organic electroconductive polymer coating liquid according to claim 2, wherein the polyhydric alcohol is at least one selected from ethylene glycol, propylene glycol, diethylene glycol, triethylene glycol or tetraethylene glycol.

11. An organic electroconductive polymer film formed by application of the organic electroconductive polymer coating liquid according to claim 1, and drying the coating liquid.

12. The organic electroconductive polymer film according to claim 11, wherein the surface resistance at 25° C. and 50% RH is within the range of from 100 Ω/sq to 3000 Ω/sq.

13. The organic electroconductive polymer film according to claim 11, wherein the value of the in-plane fluctuation of surface resistance (CV value) at 25° C. and 50% RH as represented by the following formula is from 0% to less than 5.0%:
CV value=(standard deviation of surface resistance)/(average value of surface resistance)×100.

14. The organic electroconductive polymer film according to claim 11, further comprising at least one of a hydroxamic acid derivative or a phosphoric acid derivative.

15. The organic electroconductive polymer film according to claim 11, further comprising a dielectric layer laminated thereon.

16. An electric conductor comprising the organic electroconductive polymer film according to claim 11 provided on a support.

17. A resistive film touch panel comprising:
a first electric conductor having an electroconductive film on a transparent film that is a support, and
a second electric conductor having an electroconductive film on a substrate that is a support, provided such that the electroconductive films of the first electric conductor and the second electric conductor are opposed to each other,
wherein at least one electroconductive film of the first electric conductor and the second electric conductor is the organic electroconductive polymer film according to claim 11.

18. The resistive film touch panel according to claim 17, wherein the linearity of the internal resistance value with respect to the positional variant is from −3.0% to 3.0%.
